(19) United States
(12) Patent Application Publication
(10) Pub. No.: US 2026/0280139 A1
(43) Pub. Date: Sep. 17, 2026

(54) RADIO-WAVE REFLECTING ELEMENT, INTELLIGENT REFLECTING SURFACE INCLUDING THE RADIO-WAVE REFLECTING ELEMENT, AND ANTENNA

(71) Applicant: Japan Display Inc., Tokyo (JP)

(72) Inventors: Mitsutaka OKITA, Tokyo (JP); Shinichiro OKA, Tokyo (JP)

(73) Assignee: Japan Display Inc., Tokyo (JP)

(21) Appl. No.: 19/667,954

(22) Filed: May 5, 2026

Related U.S. Application Data
(63) Continuation of application No. PCT/JP2024/039924, filed on Nov. 11, 2024.

(30) Foreign Application Priority Data
Dec. 7, 2023 (JP) 2023-206895

(51) Int. Cl. H01Q 19/10; H01Q 3/36

(52) U.S. Cl. CPC H01Q 19/10; H01Q 3/36

(57) ABSTRACT

A radio-wave reflecting element includes a patch electrode, an insulating film, an auxiliary electrode, a liquid crystal layer, and a counter electrode. The insulating film is located over the patch electrode. The auxiliary electrode is located over the insulating film and has at least one slit or cutoff overlapping the patch electrode. The liquid crystal layer is located over the auxiliary electrode, and the counter electrode is located over the liquid crystal layer. The patch electrode and the auxiliary electrode are configured to be independently applied with a variable potential.

### CROSS-REFERENCE TO RELATED APPLICATIONS

This application is a Continuation of International Patent Application No. PCT/JP2024/039924, filed on Nov. 11, 2024, which claims the benefit of priority to Japanese Patent Application No. 2023-206895, filed on Dec. 7, 2023, the entire contents of each are incorporated herein by reference.

### FIELD

An embodiment of the present invention relates to a radio-wave reflecting element utilizing liquid crystals, an intelligent reflecting surface including the radio-wave reflecting element, and a driving method thereof. Alternatively, an embodiment of the present invention relates to a phase shifter utilizing liquid crystals, an antenna including the phase shifter, a phased array antenna on which the antenna is mounted, and a driving method thereof.

### BACKGROUND

Since liquid crystal molecules have anisotropic permittivity, the permittivity of a liquid crystal layer can be controlled by adjusting the electric field applied to the liquid crystal layer containing liquid crystal molecules to control the orientation of the liquid crystal molecules. Application of these characteristics realizes a radio-wave reflecting plate capable of controlling the reflection angle of incident radio waves and a phased array antenna capable of transmitting directional radio waves in desired directions (see, for example, Japanese Patent Application Publications No. H11-103201, 2019-530387, and 2022-25914).

### SUMMARY

An embodiment of the present invention is a radio-wave reflecting element. The radio-wave reflecting element includes a patch electrode, an insulating film, an auxiliary electrode, a liquid crystal layer, and a counter electrode. The insulating film is located over the patch electrode. The auxiliary electrode is located over the insulating film and has at least one slit or cutoff overlapping the patch electrode. The liquid crystal layer is located over the auxiliary electrode, and the counter electrode is located over the liquid crystal layer. The patch electrode and the auxiliary electrode are configured to be independently applied with a variable potential.

An embodiment of the present invention is an intelligent reflecting surface. The intelligent reflecting surface includes a plurality of radio-wave reflecting elements arranged in a matrix shape having a plurality of rows and a plurality of columns. Each of the plurality of radio-wave reflecting elements includes a patch electrode, an insulating film, an auxiliary electrode, a liquid crystal layer, and a counter electrode. The insulating film is located over the patch electrode. The auxiliary electrode is located over the insulating film and has at least one slit or cutoff overlapping the patch electrode. The liquid crystal layer is located over the auxiliary electrode. The counter electrode is located over the liquid crystal layer and is shared by the plurality of radio-wave reflecting elements. The patch electrode and the auxiliary electrode are configured to be independently applied with a variable potential.

An embodiment of the present invention is an antenna. The antenna includes an antenna electrode and a phase shifter. The phase shifter includes a microstrip line, an insulating film, an auxiliary electrode, a liquid crystal layer, and a counter electrode. The microstrip line exists in the same layer as the antenna electrode. The insulating film is located over the microstrip line. The auxiliary electrode is located over the insulating film and has at least one slit or a cutoff overlapping the microstrip line. The liquid crystal layer is located over the auxiliary electrode, and the counter electrode is located over the liquid crystal layer. The antenna electrode is electrically insulated from the microstrip line through the insulating film.

An embodiment of the present invention is a phased array antenna. The phased array antenna includes a plurality of antennas. Each of the plurality of antennas includes an antenna electrode and a phase shifter. The phase shifter includes a microstrip line, an insulating film, an auxiliary electrode, a liquid crystal layer, and a counter electrode. The microstrip line exists in the same layer as the antenna electrode. The insulating film is located over the microstrip line. The auxiliary electrode is located over the insulating film and has at least one slit or cutoff overlapping the microstrip line. The liquid crystal layer is located over the auxiliary electrode, and the counter electrode is located over the liquid crystal layer. The antenna electrode is electrically insulated from the microstrip line through the insulating film.

### BRIEF DESCRIPTION OF DRAWINGS

FIG. 1 is a schematic top view of an intelligent reflecting surface according to an embodiment of the present invention.

FIG. 2 is a schematic top view of a radio-wave reflecting element according to an embodiment of the present invention.

FIG. 3 is a schematic cross-sectional view of a radio-wave reflecting element according to an embodiment of the present invention.

FIG. 4 is a schematic cross-sectional view of a radio-wave reflecting element according to an embodiment of the present invention.

FIG. 5 is a schematic top view of a radio-wave reflecting element according to an embodiment of the present invention.

FIG. 6 is an example of a timing chart of an intelligent reflecting surface according to an embodiment of the present invention.

FIG. 7 is a schematic cross-sectional view for explaining a driving method of an intelligent reflecting surface according to an embodiment of the present invention.

FIG. 8 is a schematic cross-sectional view for explaining a driving method of an intelligent reflecting surface according to an embodiment of the present invention.

FIG. 9 is a schematic cross-sectional view for explaining a driving method of an intelligent reflecting surface according to an embodiment of the present invention.

FIG. 10 is a schematic cross-sectional view for explaining a driving method of an intelligent reflecting surface according to an embodiment of the present invention.

FIG. 11 is a schematic cross-sectional view for explaining a driving method of an intelligent reflecting surface according to an embodiment of the present invention.

FIG. 12 is a schematic cross-sectional view for explaining a driving method of an intelligent reflecting surface according to an embodiment of the present invention.

FIG. 13 is a schematic top view of a radio-wave reflecting element according to an embodiment of the present invention.

FIG. 14 is a schematic top view of a phased array antenna according to an embodiment of the present invention.

FIG. 15 is a schematic top view of an antenna according to an embodiment of the present invention.

FIG. 16 is a schematic cross-sectional view of an antenna according to an embodiment of the present invention.

FIG. 17 is a schematic cross-sectional view of an antenna according to an embodiment of the present invention.

FIG. 18 is a schematic cross-sectional view of an antenna according to an embodiment of the present invention.

FIG. 19 is an example of a timing chart of an antenna according to an embodiment of the present invention.

FIG. 20 is a schematic view for explaining a driving method of an intelligent reflecting surface according to an embodiment of the present invention.

FIG. 21 is a schematic view for explaining a driving method of an intelligent reflecting surface according to an embodiment of the present invention.

### DESCRIPTION OF EMBODIMENTS

Hereinafter, each embodiment of the present invention is explained with reference to the drawings. The invention can be implemented in a variety of different modes within its concept and should not be interpreted only within the disclosure of the embodiments exemplified below.

The drawings may be illustrated so that the width, thickness, shape, and the like are illustrated more schematically compared with those of the actual modes in order to provide a clearer explanation. However, they are only an example, and do not limit the interpretation of the invention. In the specification and the drawings, the same reference number is provided to an element that is the same as that which appears in preceding drawings, and a detailed explanation may be omitted as appropriate. When a plurality of structures the same as or similar to one another is represented, a reference number is used, and a hyphen and a natural number are added after the reference number when the plurality of structures is independently represented. When a portion of one structure is represented, a small letter of an alphabet is used after the reference number.

In the specification and the claims, unless specifically stated, when a state is expressed where a structure is arranged “over” another structure, such an expression includes both a case where the substrate is arranged immediately above the “other structure” so as to be in contact with the “other structure” and a case where the structure is arranged over the “other structure” with an additional structure therebetween.

In the specification and claims, an expression that a structure is exposed from another structure means a mode where the portion of the structure is not covered by the other structure and includes a mode where the portion uncovered by the other structure is further covered by another structure. In addition, a mode expressed by this expression includes a mode where the structure is not in contact with the other structures.

In the present invention, when a plurality of films is simultaneously fabricated in the same process to form a plurality of films, these films may have different functions and roles. However, these films originate from a film formed as one layer in the same process. Hence, these films are defined as existing in the same layer.

In the specification and claims, an expression that two structures are “orthogonal” includes not only a state where these two structures intersect perpendicularly (90°) but also a state where these two structures intersect at an angle of 90°±10°. Similarly, an expression that two structures are “parallel” includes not only a state where an angle between the extending directions of these two structures is 0° but also a state where the angle is 0°±10°.

### First Embodiment

Hereinafter, a radio-wave reflecting element according to an embodiment of the present invention and an intelligent reflecting surface including the radio-wave reflecting element as well as a driving method of the ratio-wave reflector are explained.

### 1. Intelligent Reflecting Surface

### (1) Overall Structure of Intelligent Reflecting Surface

The intelligent reflecting surface according to an embodiment of the present invention is a so-called liquid crystal metasurface reflector and is a device which realizes a function to reflect incident radio waves in arbitral directions by utilizing the permittivity change resulting from the orientation change of the liquid crystal layer by an electric field. There are no restrictions on the frequency of the wavelengths which can be reflected, and the frequency is in the range of 400 MHz to 50 GHz, for example. Typically, the intelligent reflecting surface can be used to reflect radio waves in the 400 MHz to 6.0 GHz band, the 2.5 GHz to 4.7 GHZ band, and the 24 GHz to 50 GHz band.

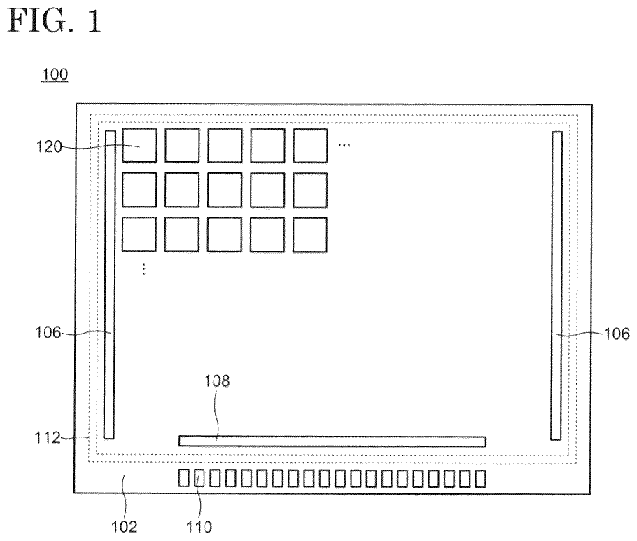

FIG. 1 shows a schematic top view of the intelligent reflecting surface 100. The intelligent reflecting surface 100 has a substrate 102 and a counter substrate, which is not illustrated in FIG. 1, between which a variety of patterned insulating films, semiconductor films, and conductive films, and a liquid crystal layer, and the like are arranged. Appropriate stacking of these films leads to the formation of a plurality of radio-wave reflecting elements 120 arranged in a matrix shape having a plurality of rows and a plurality of columns. In addition to the radio-wave reflecting elements 120, the radio wave reflective device 100 has a scanning-line driver circuit 106 and a signal-line driver circuit 108 for respectively supplying scanning signals and control signals to the radio-wave reflecting elements 120. The scanning-line driver circuit 106 and the signal-line driver circuit 108 may be formed with insulating films, semiconductor films, and conductive films formed over the substrate 102 or by mounting an integrated circuit formed over a semiconductor substrate over the substrate 102. The number of scanning-line driver circuits 106 and signal-line driver circuits 108 may be one or more. For example, two scanning-line driver circuits 106 may be arranged over the substrate 102 so as to sandwich the plurality of radio-wave reflecting elements 120 as shown in FIG. 1. The signal-line driver circuit 108 is disposed on an edge side of the substrate 102.

Although not illustrated in FIG. 1, a plurality of scanning lines (hereinafter referred to as gate lines) and a plurality of signal lines respectively extend from the scanning-line driver circuits 106 and the signal-line driver circuit 108 and are electrically connected to the radio-wave reflecting elements 120. Accordingly, the radio-wave reflecting elements 120 are electrically connected to the corresponding gate lines and signal lines. A plurality of terminals 110 is further formed over the substrate 102, and a variety of signals for driving the radio-wave reflecting elements 120 is supplied via the terminals 110 from an external circuit which is not illustrated. The scanning-line driver circuits 106 and the signal-line driver circuit 108 respectively generate scanning signals and control signals on the basis of the supplied signals and supply them to the radio-wave reflecting elements 120.

### (2) Structure of Radio-Wave Reflecting Element

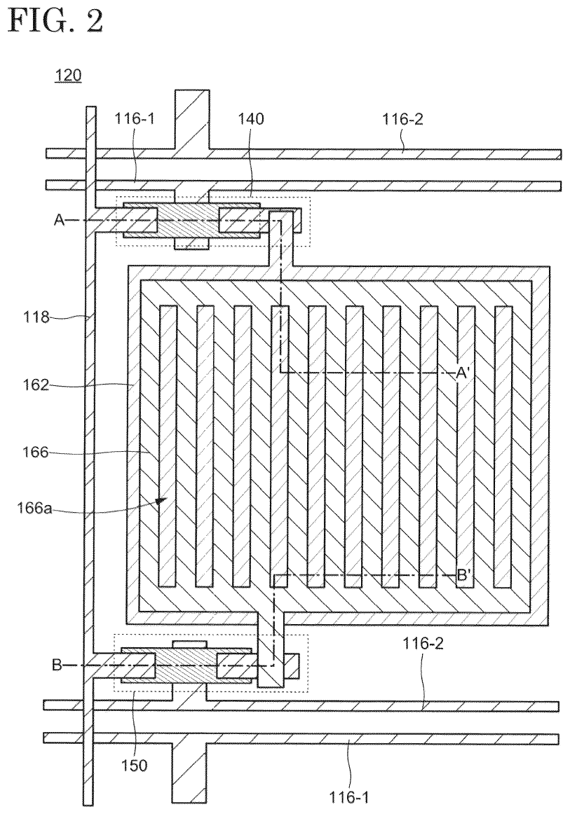

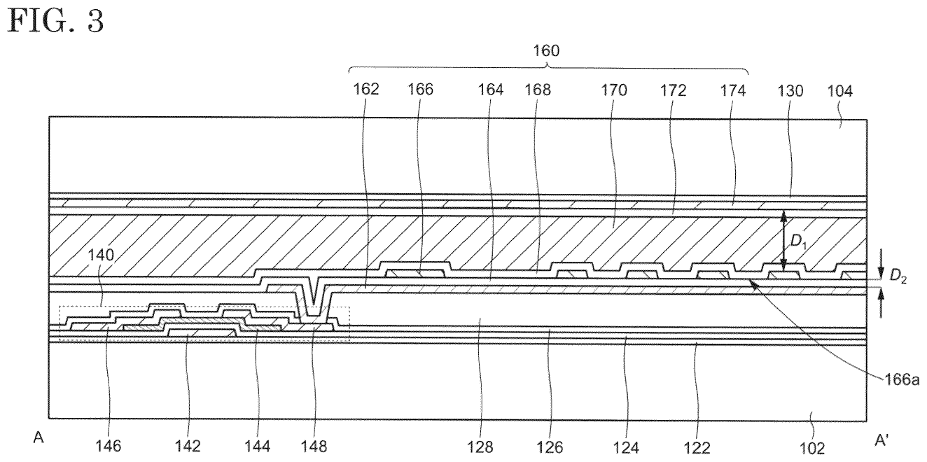

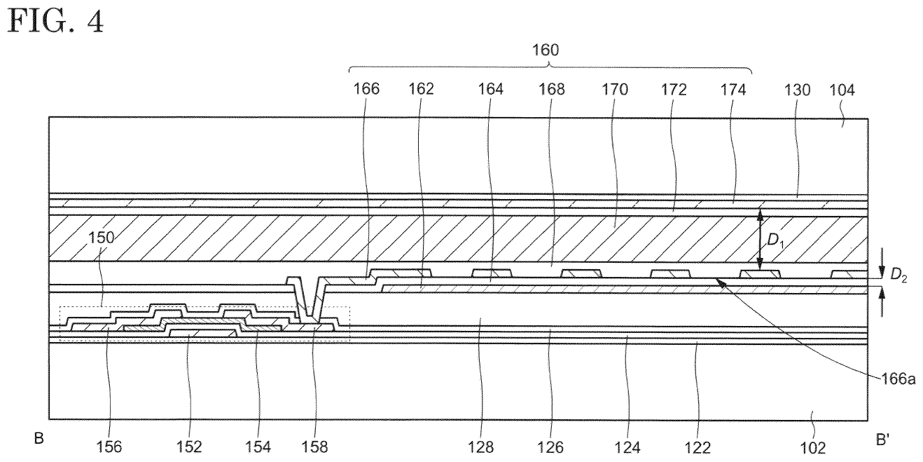

A schematic top view of one radio-wave reflecting element 120 is shown in FIG. 2, and schematic views of the cross sections along the chain lines A-A′ and B-B′in FIG. 2 are shown in FIG. 3 and FIG. 4, respectively. In FIG. 2, a part of the configurations of the radio-wave reflecting elements 120 adjacent to each other in the column direction (second gate line 116-2 and first gate line 116-1) are depicted.

As shown in FIG. 2, the intelligent reflecting surface 100 has two gate lines (first gate line 116-1 and second gate line 116-2) for supplying the scanning signals to the plurality of radio-wave reflecting elements 120 arranged in each of the plurality of rows as well as the signal lines 118, each of which supply the control signals to the plurality of radio-wave reflecting elements 120 arranged in each of the plurality of columns. The first gate lines 116-1 and the second gate lines 116-2 extend in the row direction, while the signal lines 118 extend in the column direction. In other words, each of the signal lines 118 intersects the first gate line 116-1 and second gate line 116-2.

Each radio-wave reflecting element 120 has at least two transistors (first transistor 140 and second transistor 150), and a portion of each of the first gate line 116-1 and the second gate line 116-2 respectively constitutes the gate electrodes of the first transistor 140 and the second transistor 150. In other words, the first transistor 140 and the second transistor 150 are connected to different gate lines, i.e., the first gate line 116-1 and the second gate line 116-2, respectively. Thus, the first gate line 116-1 is electrically connected to the gate electrodes of the first transistors 140 of the plurality of radio-wave reflecting elements 120 provided in the row in which this first gate line 116-1 is disposed. On the other hand, the second gate line 116-2 is electrically connected to the gate electrodes of the second transistors 150 of the plurality of radio-wave reflecting elements 120 provided in the row in which this second gate line 116-2 is disposed. The first gate line 116-1 and the second gate line 116-2 are individually supplied with potentials from the scanning-line driver circuit 106. Thus, the first transistor 140 and the second transistor 150 can be independently driven and controlled from each other in each radio-wave reflecting element 120.

A part of the signal line 118 serves as a terminal 146 of the first transistor 140 and another part thereof serves as a terminal 156 of the second transistor 150 (see FIG. 3 and FIG. 4) in each row. Thus, when focusing on one radio-wave reflecting element 120, the signal line 118 is electrically connected to the first transistor 140 and the second transistor 150 of this radio-wave reflecting element 120 and is further electrically connected to the first transistors 140 and the second transistors 150 of the radio-wave reflecting elements 120 in the same column as this radio-wave reflecting element 120.

Therefore, the number of gate lines 116 is twice as large as that of a normal liquid crystal display. However, since the number of radio-wave reflecting elements in an intelligent reflecting surface is generally much smaller than the number of pixels formed in a liquid crystal display, the load on the scanning-line driver circuits 106 is small. Hence, all of the radio-wave reflecting elements 120 can be switched on and off at high speed by the scanning-line driver circuit 106.

As shown in FIG. 3 and FIG. 4, the first transistor 140 and the second transistor 150 are provided over the substrate 102 either directly or through an undercoat 122 which is an optional component. In the example shown in FIG. 2 and FIG. 3, the first transistor 140 is fabricated with a gate electrode 142, a gate insulating film 124 over the gate electrode 142, a semiconductor film 144 located over the gate insulating film 124 and overlapping the gate electrode 142, and terminals 146 and 148 electrically connected to the semiconductor film 144. Similarly, the second transistor 150 is fabricated with a gate electrode 152, a gate insulating film 124 over the gate electrode 152, a semiconductor film 154 located over the gate insulating film 124 and overlapping the gate electrode 152, and terminals 156 and 158 electrically connected to the semiconductor film 154. In the example shown in FIG. 2 to FIG. 4, the first transistor 140 and the second transistor 150 both have a bottom gate structure. However, there is no restriction on their structures, and the first transistor 140 and the second transistor 150 may also have a top gate structure or each include gate electrodes over and under the semiconductor film. There is also no restriction on the vertical relationship between the terminals 146 and 148 and the semiconductor film 144, and the former may be located below the latter. The same is applied for the vertical relationship between the terminals 156 and 158 and the semiconductor film 154.

A leveling film 128 is provided over the first transistor 140 and the second transistor 150 to absorb the unevenness caused by these elements and provide a flat surface. As an optional component, a first interlayer insulating film 126 may be provided between the first transistor 140 and the second transistor 150 and the leveling film 128.

Since the above-described components can be formed by employing known structures and materials as appropriate, a detailed description is omitted. In brief, the substrate 102 may include an inorganic insulator such as glass and quartz, a semiconductor such as silicon, a polymer such as a polyimide, a polycarbonate and a polyester, or a metal such as aluminum, copper, and stainless steel. When a conductive material such as a metal is included, it is preferable to provide the undercoat 122 over the surface over which the radio-wave reflecting elements 120 are provided, i.e., the surface of the substrate 102 on the counter substrate 104 side. The substrate 102 may or may not transmit visible light. Moreover, the substrate 102 may be flexible. The undercoat 122, the gate insulating film 124, the first interlayer insulating film 126, and the like may be formed with one or more layers containing a silicon-containing inorganic compound such as silicon oxide and silicon nitride. The gate insulating film 124 may be configured to include a so-called high-k material such as hafnium silicate, hafnium silicate containing nitrogen, hafnium oxide, nitrogen-doped hafnium aluminate, and yttrium oxide. The gate lines 116, the signal lines 118, the gate electrodes 142 and 152, and the terminals 146, 148, 156, and 158 may be configured to include a metal such as titanium, molybdenum, tungsten, copper, aluminum, and alloys containing a metal selected from these metals. The semiconductor films 144 and 154 may include a Group 14 element such as silicon or may be formed as a film containing an oxide of a Group 13 element such as indium or gallium. The leveling film 128 may be configured to include a polymer, such as a polyimide, a polyamide, an acrylic resin, and a silicon resin.

Although only the first transistor 140 and the second transistor 150 are shown between the leveling film 128 and the substrate 102 in FIG. 2 to FIG. 4, each radio-wave reflecting element 120 may further include a variety of elements such as one or more transistors and one or more capacitor elements.

A liquid crystal element 160 is provided over the leveling film 128. The liquid crystal element 160 includes, as its fundamental components, a first electrode (hereinafter, referred to as a patch electrode) 162, a second electrode (hereinafter, referred to as an auxiliary electrode) 166, a second interlayer insulating film 164, a first orientation film 168, a second orientation film 172, a liquid crystal layer 170, and a counter electrode 174.

The patch electrode 162 is electrically connected to one terminal 148 of the first transistor 140 through an opening prepared in the leveling film 128 and the first interlayer insulating film 126. As a result, when the first transistor 140 is turned on, the control signal is applied to the patch electrode 162 from the signal line 118 via the terminal 146, the semiconductor film 144, and the terminal 148. On the other hand, the auxiliary electrode 166 is electrically connected to one terminal 158 of the second transistor 150 through an opening prepared in the leveling film 128, the first interlayer insulating film 126, and the second interlayer insulating film 164. Accordingly, when the second transistor 150 is turned on, the control signal is applied from the signal line 118 to the auxiliary electrode 166 via the terminal 156, the semiconductor film 154, and the terminal 158. Therefore, arbitral potentials (i.e., variable potentials) can be supplied to the patch electrode 162 and the auxiliary electrode 166 by switching the first transistor 140 and the second transistor 150 on and off as appropriate. The patch electrode 162 and the auxiliary electrode 166 may be configured to include the metals or alloys described above or may include a conductive oxide exhibiting a light-transmitting property, such as indium-tin oxide (ITO) and indium-zinc oxide (IZO).

There are no restrictions on the shape (planar shape) of the patch electrode 162, and the patch electrode 162 is preferred to have a shape with a plurality of symmetrical axes intersecting each other, such as regular polygons including a square. Employment of such a shape enables efficient reflection for both vertically and horizontally polarized waves of incident radio waves.

Here, the auxiliary electrode 166 has at least one, preferably a plurality of, slits 166a. The slit 166a overlaps the patch electrode 162, and thus a portion of the patch electrode 162 is exposed from the auxiliary electrode 166. The length and the width of the slit 166a are selected according to the frequency of the radio waves to be reflected. For example, the length is equal to or greater than 2 mm and equal to or less than 100 mm or equal to or greater than 2 mm and equal to or less than 30 mm, while the width is equal to or greater than 1 μm and equal to or less than 100 μm or equal to or greater than 1 μm and equal to or less than 10 μm. Therefore, the aspect ratio (length/width) of the slit 166a also depends on the frequency of the radio waves to be reflected and is, for example, equal to or greater than 10 and equal to or less than 10000. The number of slits 166a on each auxiliary electrode 166 is also selected according to the frequency of the radio waves. Although the slits 166a extend in a straight line in the example shown in FIG. 2, each slit 166a may have one or a plurality of bent portions. Here, a slit is an opening in a film, and the contour of a slit has a closed shape and is independent from the outermost periphery of the film.

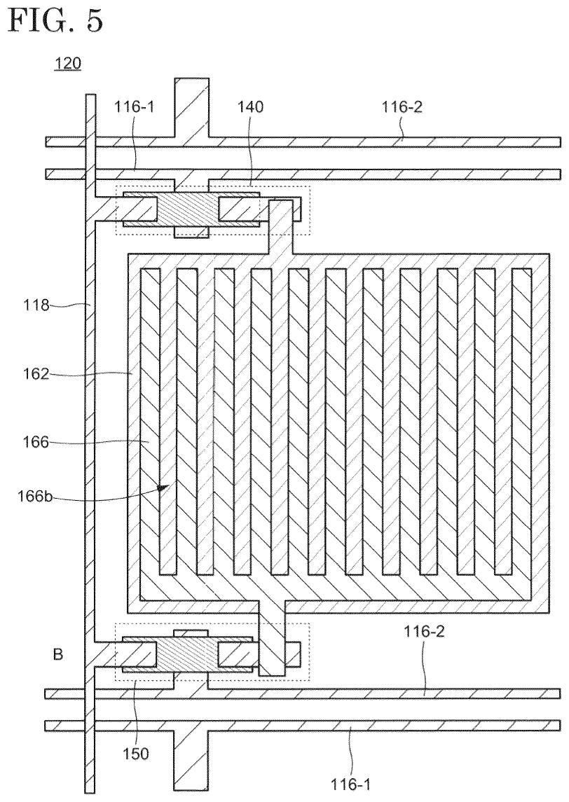

Alternatively, the auxiliary electrode 166 may have one or a plurality of cutoffs 166b instead of the slit 166a as shown in FIG. 5. Thus, the auxiliary electrode 166 may have a comb shape. Here, a cutoff is an apparent deficiency in a film, which has an open contour and constitutes part of the outermost periphery of the film. The cutoff 166b is located between adjacent comb teeth, and the patch electrode 162 is exposed at the cutoff 166b. The length, the width, and the aspect ratio of the cutoff 166b may also be set appropriately from the aforementioned ranges for the length, the width, and the aspect ratio of the slit 166a, respectively.

The second interlayer insulating film 164 is sandwiched between the patch electrode 162 and the auxiliary electrode 166 to electrically insulate these components. Thus, the second interlayer insulating film 164 may also be composed of one or a plurality of films containing a silicon-containing inorganic compound, for example.

The first orientation film 168 and the second orientation film 172 are each provided to cover the patch electrode 162 and the auxiliary electrode 166 and to sandwich the liquid crystal layer 170. The first orientation film 168 and the second orientation film 172 are provided to control the orientation of the liquid crystal molecules structuring the liquid crystal layer 170 therebetween. The first orientation film 168 and the second orientation film 172 may be continuously provided over the plurality of radio-wave reflecting elements 120. In other words, the first orientation film 168 and the second orientation film 172 may be provided so as not to be divided between adjacent radio-wave reflecting elements 120 and to be shared by all of the radio-wave reflecting elements 120.

The first orientation film 168 and the second orientation film 172 each contain a polymer such as a polyimide and a polyester. The first orientation film 168 and the second orientation film 172 are formed by utilizing a wet film-forming method such as an ink-jet method, a spin-coating method, a printing method, and a dip-coating method, and the surfaces thereof are subjected to a rubbing treatment. Alternatively, the first orientation film 168 and the second orientation film 172 may be formed by a photo-alignment treatment. The rubbing or photo-alignment treatment allows the first orientation film 168 and the second orientation film 172 to orient the liquid crystal molecules in a certain direction along the main surfaces of the substrate 102 and the counter substrate 104. Therefore, the liquid crystal molecules are homogeneously oriented, and their long axis direction is approximately parallel to the main surface of the substrate 102 in the absence of an electric field in the liquid crystal layer 170. The direction in which the first orientation film 168 and the second orientation film 172 orient the liquid crystal molecules (orientation direction) may be set arbitrarily and may be parallel or perpendicular to the longitudinal direction of the slit 166a or the cutoff 166b or may be inclined at an arbitral angle from the longitudinal direction. In addition, the orientation directions of the first orientation film 168 and the second orientation film 172 may be the same as or different from each other. For example, the orientation directions of the first orientation film 168 and the second orientation film 172 may be orthogonal to each other.

The liquid crystal layer 170 contains the liquid crystal molecules. The structure of the liquid crystal molecules is not limited. Thus, the liquid crystal molecules may be nematic liquid crystals, smectic liquid crystals, cholesteric liquid crystals, or chiral smectic liquid crystals. The thickness of the liquid crystal layer 170 is, for example, equal to or greater than 20 μm and equal to or less than 100 μm or equal to or greater than 30 μm and equal to or less than 50 μm. Although not illustrated, spacers may be provided in the liquid crystal layer 170 in order to maintain this thickness throughout the intelligent reflecting surface 100.

The counter electrode 174 may be provided as a single electrode integrated across the plurality of radio-wave reflecting elements 120 to be shared by the plurality of radio-wave reflecting elements 120. Therefore, the counter electrode 174 is also referred to as a common electrode. Since the radio-wave reflecting elements 120 may or may not transmit visible light, the counter electrode 174 may include the aforementioned metal or alloy or a conductive oxide such as ITO and IZO, similar to the patch electrode 162 and the auxiliary electrode 166. The counter electrode 174 is supplied with a common potential, which is a constant potential, from an external circuit (not illustrated) either directly or through the signal-line driver circuit 108. The potential difference between the counter electrode 174 and the patch electrode 162 and/or between the counter electrode 174 and the auxiliary electrode 166 generates a longitudinal electric field in the liquid crystal layer 170, and this longitudinal electric field changes the orientation of the liquid crystal molecules, thereby controlling the permittivity of the liquid crystal layer 170.

Here, the liquid crystal element 160 is configured so that the distance D2 between the patch electrode 162 and the auxiliary electrode 166 (the distance from a top surface of the patch electrode 162 to a bottom surface of the auxiliary electrode 166) is smaller than the distance D₁ between the auxiliary electrode 166 and the counter electrode 174 (the distance from a top surface of the auxiliary electrode 166 to a bottom surface of the counter electrode 174). The distance D₂ is mainly determined by the second interlayer insulating film 164 and is, for example, equal to or greater than 50 nm and equal to or less than 5 μm. The distance D₁ is mainly determined by the liquid crystal layer 170, the first orientation film 168, and the second orientation film 172. For example, the distance D₂ may be set within a range equal to or greater than 100 times and equal to or less than 1000 times or equal to or greater than 100 times and equal to or less than 500 times the distance D₁.

The counter substrate 104 may have the same configuration as the substrate 102. The substrate 102 and the counter substrate 104 are sealed with a sealing material 112 (FIG. 1), and the liquid crystal layer 170 is sealed within the space created by the sealing material 112, the substrate 102, and the counter substrate 104. As shown in FIG. 3 and FIG. 4, an undercoat 130 may be provided on the liquid crystal layer 170 side of the counter substrate 104 to prevent impurities in the counter substrate 104 from diffusing toward the liquid crystal layer 170 side. The undercoat 130 may have the same configuration as the undercoat 122.

### 2. Driving Method of Intelligent Reflecting Surface

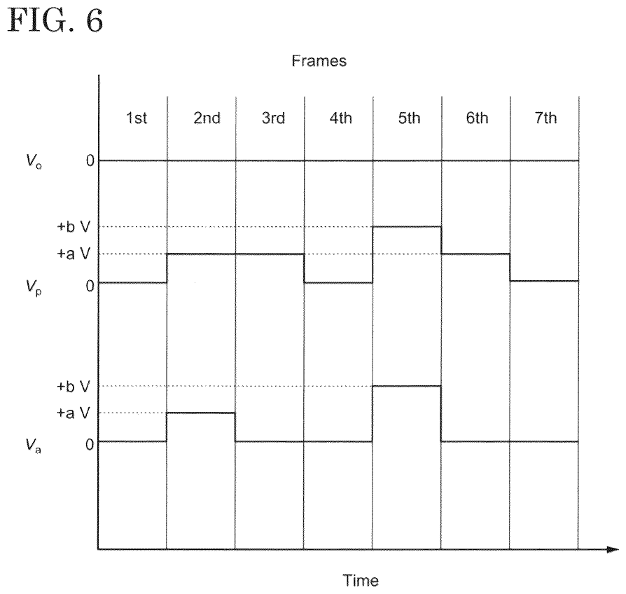

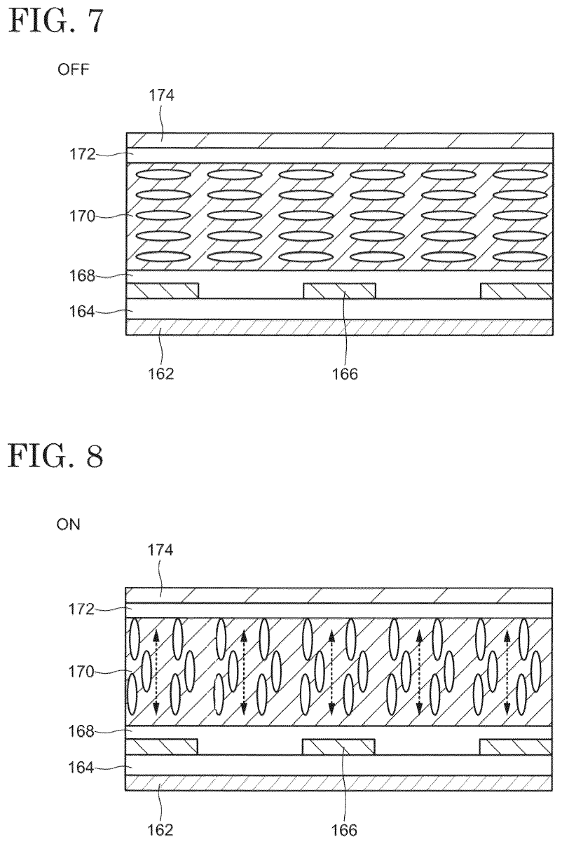

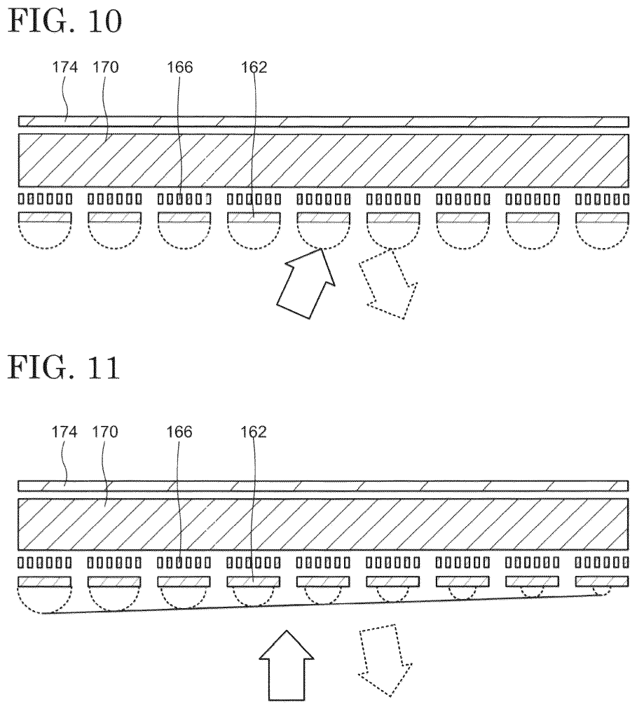

Hereinafter, a driving method of the intelligent reflecting surface 100 is explained using FIG. 6 to FIG. 12. FIG. 6 is an example of a timing chart for driving the intelligent reflecting surface 100, where the changes of the potentials applied to the counter electrode 174, the patch electrode 162, and the auxiliary electrode 166 in seven consecutive frames are schematically shown for one radio-wave reflecting element 120. FIG. 7 to FIG. 9 are schematic cross-sectional views of a portion of one radio-wave reflecting element 120, and FIG. 10 to FIG. 12 are schematic cross-sectional views of the plurality of radio-wave reflecting elements 120. For visibility, only a portion of these components is illustrated in these drawings, and only the patch electrode 162, the auxiliary electrode 166, the liquid crystal layer 170, and the counter electrode 174 are shown in FIG. 10 to FIG. 12, for example. In FIG. 7 to FIG. 9, the liquid crystal molecules are schematically shown using ellipses.

According to the timing chart in FIG. 6, the intelligent reflecting surface 100 is in the off state in the first frame, the fourth frame, and the seventh frame. In contrast, the intelligent reflecting surface 100 is in the on state in the second frame and the fifth frame in which an electric field is formed in the liquid crystal layer 170. Thus, the reflection direction of the incident radio waves is controlled in the second frame and the fifth frame. In the example shown here, the electric field strength formed in the liquid crystal layer 170 in the second frame and the fifth frame differs from each other, and the latter is larger than the former. The third frame and the sixth frame are also referred to as an overdrive period and enable high-speed switching of the reflection direction of radio waves as described below.

### (1) Off State

In the first frame, the same potential is supplied to the patch electrode 162, the auxiliary electrode 166, and the counter electrode 174 in all of the radio-wave reflecting elements 120. Although the following description is provided here assuming that this potential is the ground potential (0 V), the potentials applied to the patch electrode 162, the auxiliary electrode 166, and the counter electrode 174 are relative to an arbitrarily determined potential. In this state, these electrodes are equipotential to each other so that no electric field is caused in the liquid crystal layer 170, and the liquid crystal molecules in the liquid crystal layer 170 are homogeneously oriented according to the orientation directions of the first orientation film 168 and the second orientation film 172 (FIG. 7). Accordingly, the permittivity of the liquid crystal layer 170 is the same in all of the radio-wave reflecting elements 120. Therefore, as represented by the dotted arcs in FIG. 10 which is a schematic cross-sectional view of the plurality of radio-wave reflecting elements 120, the spread (phase) of the reflected radio waves, which are generated when the radio waves (solid white arrow in FIG. 10) incident from the patch electrode 162 side are reflected at the surface of the counter electrode 174, does not change. Therefore, the incident radio waves are directly reflected by the intelligent reflecting surface 100, resulting in the reflected radio waves (dotted white arrow in FIG. 10) with the same emission angle as the incident angle.

### (2) On State

In the second frame following the first frame, the radio-wave reflecting elements 120 are turned on. Specifically, the potential V₀ of the counter electrode 174 is maintained at 0 V, and the first transistor 140 is turned on, while the second transistor 150 is kept in the off state in each radio-wave reflecting element 120. In this state, an arbitrary potential different from the ground potential (here, a potential of +aV) is supplied to the patch electrode 162 from the signal line 118. As a result, the potential Vₚ of the patch electrode 162 becomes +aV.

The first transistor 140 is then transferred to the off state. As a result, the potential Vₚ of the patch electrode 162 is maintained at +aV. Next, the second transistor 150 is turned on while maintaining the first transistor 140 in the off state. In this state, an arbitrary potential different from the ground potential (in this case, a potential of +aV) is supplied from the signal line 118. As a result, the potential Vₐ of the auxiliary electrode 166 becomes a₁V. Although the potential Vₐ of the auxiliary electrode 166 is set after setting the potential Vₚ of the patch electrode 162 in the explanation above, the order is arbitrary. Moreover, the potential Vₚ of the patch electrode 162 and the potential Vₐ of the auxiliary electrode 166 may be the same as or different from each other, but the potentials of these electrodes are preferred to be the same to avoid generating a transverse electric field by the potential difference between the patch electrode 162 and auxiliary electrode 166.

The aforementioned operation generates a potential difference between the patch electrode 162 and the counter electrode 174 and between the auxiliary electrode 166 and the counter electrode 174, resulting in a longitudinal electric field in the liquid crystal layer 170 (see the dotted arrows in FIG. 8). The potential Vₚ of the patch electrode 162 and the potential Vₐ of the auxiliary electrode 166 at this time are determined by the reflection direction of the incident radio waves. The phase change of the reflected radio waves depends on the change in permittivity of the liquid crystal layer 170, and the phase change increases with increasing change in permittivity. Furthermore, the change in permittivity also depends on the intensity of the electric field generated in the liquid crystal layer 170. Therefore, when the phase of the reflected radio waves is to be significantly changed, potentials significantly different from the potential Vₒ of the counter electrode 174 may be applied to the patch electrode 162 and the auxiliary electrode 166.

When the longitudinal electric field is generated, the liquid crystal molecules rise depending on the intensity of the electric field, and their long axis direction approaches the direction of the electric field, allowing the liquid crystal molecules to adopt a bend orientation, a homeotropic orientation, or an orientation similar thereto. As a result, the permittivity of the liquid crystal layer 170 changes due to the permittivity anisotropy of the liquid crystal molecules. Therefore, it is possible to change the phase of the reflected radio waves for each radio-wave reflecting element 120 by changing the intensity of the longitudinal electric field for each radio-wave reflecting element 120 (FIG. 11). As a result, the isophase plane of the reflected radio waves can be tilted as indicated by the straight lines in FIG. 11. That is, the reflection direction of the incident radio waves (solid white arrow in FIG. 11) can be changed (see dotted white arrow in FIG. 11).

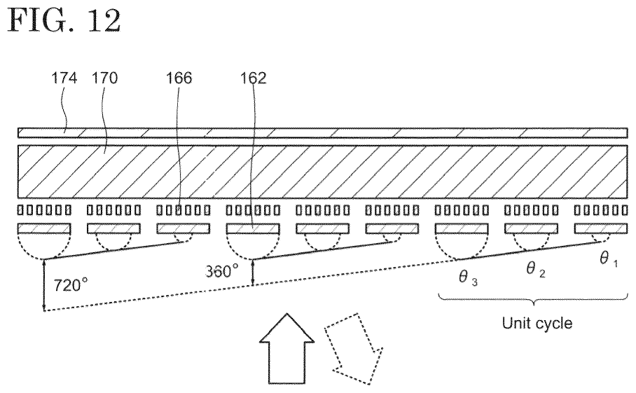

Depending on the slope of the phase plane, the radio-wave reflecting elements 120 may cause the phase change of the reflected radio waves exceeding 360°. In this case, the potential of the patch electrode 162 is controlled so that the electric field generated in the liquid crystal layer 170 periodically changes. Specifically, the intelligent reflecting surface 100 is driven so that the longitudinal electric field in the liquid crystal layer 170 changes periodically in the row direction or the column direction as shown in FIG. 12, thereby creating one unit cycle including the plurality of radio-wave reflecting elements 120 in which the intensity of the longitudinal electric field continuously increases or decreases in the row direction or the column direction. In each unit cycle, the intensity of the longitudinal electric field is adjusted so that one isophase plane represented by a solid straight line is formed. In the example demonstrated in FIG. 12, the phase change in one unit cycle varies continuously by θ₁, θ₂, and θ₃ (θ₁<θ₂<θ₃). Furthermore, the intelligent reflecting surface 100 is driven so that the phase difference in the isophase plane is 360° between adjacent unit cycles. An inclusive isotropic plane represented by the dotted straight line can be obtained by driving the intelligent reflecting surface 100 in this manner, and the reflection direction of the incident radio waves (solid white arrow in FIG. 12) can be changed (see dotted white arrow in FIG. 12).

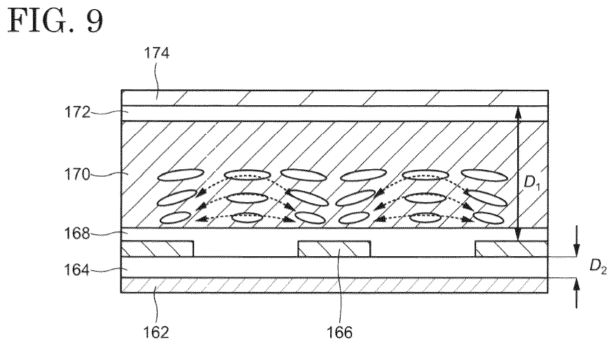

When the radio-wave reflecting elements 120 are then returned to the off state, the potential Vₐ of the auxiliary electrode 166 is returned to its initial potential of 0 V in the third frame, while changing the potential Vₒ of the counter electrode 174 to 0 V and maintaining the potential Vₚ of the patch electrode 162 at +aV. This operation creates a potential difference between the patch electrode 162 and the auxiliary electrode 166, resulting in a transverse electric field between the patch electrode 162 and the auxiliary electrode 166 as shown in FIG. 9. On the other hand, although there is still a potential difference between the patch electrode 162 and the counter electrode 174, the vertical electric field can be ignored with respect to the longitudinal electric field because the distance D₁ is extremely large compared with the distance D₂ as described above. Accordingly, the liquid crystal molecules which rise in the second frame can be forced back to their original homogeneous orientation using the transverse electric field in the third frame. The contribution of the driving force resulting from the transverse electric field can rapidly return the orientation of the liquid crystal layer 170 to its original state. Thereafter, the potential Vₚ of the patch electrode 162 is returned to its initial potential (0 V) to shift to the off state in the fourth frame.

When shifting to the on state to change the permittivity even more significantly (fifth frame), a larger potential (a potential of +bV in the example in FIG. 6, where b>a) may be applied to both the patch electrode 162 and the auxiliary electrode 166. The same is applied when shifting to the off state again, and no potential difference is formed between the auxiliary electrode 166 and the counter electrode 174, but a potential difference is provided between the auxiliary electrode 166 and the patch electrode 162 to form a transverse electric field in the sixth frame following the fifth frame. This operation allows the orientation state of the liquid crystal layer 170 to be rapidly returned to the homogeneous orientation.

Note that, although the polarity of the potentials Vₚ and Vₐ of the patch electrode 162 and auxiliary electrode 166 are the same with respect to the potential Vₒ of the counter electrode 174 in the consecutive on-state frames (here, the second frame and fifth frame) in the aforementioned example, the polarity of the potentials Vₚ and Vₐ of the patch electrode 162 and auxiliary electrode 166 may be inverted between the consecutive on-state frames. Employment of such a so-called inverted driving method prevents the burn-in of the liquid crystal layer 170.

As described above, the thickness of the liquid crystal layer 170 is significantly large in the intelligent reflecting surface 100 according to an embodiment of the present invention compared with that of a liquid crystal display device. Hence, the response speed of the liquid crystal is low, and quick switching is not attainable by the same driving method as in liquid crystal displays, e.g., IPS (In Plane Switching) liquid crystal displays. This is because only van der Waals forces between the liquid crystal molecules and the first orientation film 168 and between the liquid crystal molecules and the second orientation film 172 are available when the liquid crystal molecules return to the homogeneous orientation. In contrast, in the intelligent reflecting surface 100 according to an embodiment of the present invention, the transverse electric field between the auxiliary electrode 166 and the patch electrode 162 can be used together with the van der Waals forces when the liquid crystal molecules oriented using the longitudinal electric field to control the reflection direction of radio waves are returned to the homogeneous orientation. Therefore, the homogeneous orientation can be rapidly reproduced, and as a result, the reflective characteristics of the intelligent reflecting surface 100 can be switched at high speed. Hence, implementation of an embodiment of the present invention enables the production of an intelligent reflecting surface capable of changing the reflection direction of radio waves at high speed.

### 3. Modified Example

In the configuration described above, two gate lines 116 are arranged in each row, by which the first transistor 140 and the second transistor 150 are individually controlled. On the other hand, both the first transistor 140 and the second transistor 150 are electrically connected to the same signal line 118 in each of the plurality of radio-wave reflecting elements 120 arranged in each column. Accordingly, the patch electrode 162 and the auxiliary electrode 166 are each supplied with a potential from the same signal line 118.

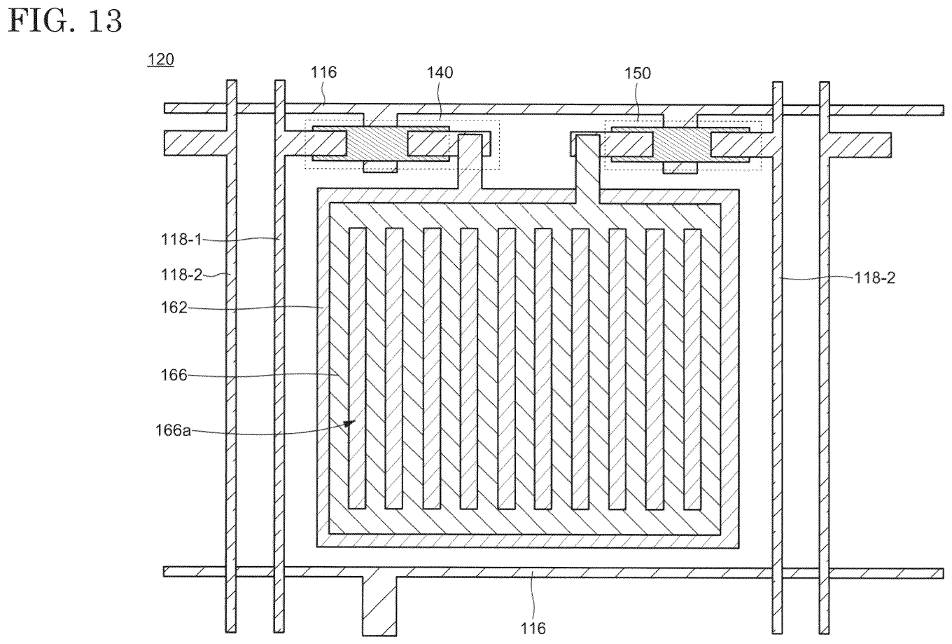

The structure of the intelligent reflecting surface 100 according to an embodiment of the present invention is not limited to that described above and can be modified in a variety of ways. For example, one gate line 116 may be provided in each row, and two signal lines (first signal line 118-1 and second signal line 118-2) may be arranged in each column as shown in FIG. 13. The first signal line 118-1 and the second signal line 118-2 extend in the column direction. A part of the first signal line 118-1 and a part of the second signal line 118-2 respectively structure terminals 146 and 156 of the first transistor 140 and the second transistor 150 in each row. In other words, the first transistor 140 and the second transistor 150 are connected to different signal lines, namely the first signal line 118-1 and the second signal line 118-2, respectively. Thus, the first signal line 118-1 is electrically connected to the terminals 146 of the first transistors of the plurality of radio-wave reflecting elements 120 arranged in the column in which this signal line is arranged. Meanwhile, the second signal line 118-2 is electrically connected to the terminals 156 of the second transistors 150 of the plurality of radio-wave reflecting elements 120 arranged in the column in which this signal line is arranged. The first signal line 118-1 and the second signal line 118-2 are individually controlled and supplied with variable potentials by the signal-line driver circuit 108. Thus, an arbitrary potential can be supplied from the first signal line 118-1 and the second signal line 118-2 to the first transistor 140 and the second transistor 150, respectively, in each radio-wave reflecting element 120.

The gate line 116 extends in the row direction and intersects the first signal lines 118-1 and the second signal lines 118-2. In each column, a part of the gate line 116 serves as the gate electrode 142 of the first transistor 140 and another part serves as the gate electrode 152 of the second transistor 150. Thus, when focusing on one radio-wave reflecting element 120, the gate line 116 is electrically connected to the first transistor 140 and the second transistor 150 of this radio-wave reflecting element 120 and is also electrically connected to the first transistor 140 and the second transistor 150 in each of the radio-wave reflecting elements in the same row as this radio-wave reflecting element 120. Thus, in each row, the first transistor and the second transistor are driven simultaneously.

Similar to the intelligent reflecting surface 100 with the radio-wave reflecting element 120 demonstrated in FIG. 2, the number of signal lines 118 in this modified example is also twice as many as in a normal liquid crystal display. However, since the number of radio-wave reflective elements in the intelligent reflecting surface is much smaller than the number of pixels provided in a liquid crystal display, the load on the signal-line driver circuit 108 is small. Therefore, it is possible to switch on and off all of the radio-wave reflecting elements 120 at high speed and supply the corresponding control signals.

In this modified example, the transverse electric field can be formed between the patch electrode 162 and the auxiliary electrode 166 by appropriately selecting the potential supplied through the first signal line 118-1 and the second signal line 118-2 in the overdrive period. Therefore, it is possible to return the liquid crystal molecules, which rise in the on state, to the homogeneous orientation, thereby enabling high-speed switching of the reflection direction of radio waves.

### Second Embodiment

In this embodiment, an antenna according to an embodiment of the present invention, a phased array antenna including the antenna, and a driving method of the phased array antenna are described. An explanation of the structures the same as or similar to those described in the First Embodiment may be omitted.

### 1. Phased Array Antenna

### (1) Overall Structure of Phased Array Antenna

A phased array antenna is a plurality of antennas arranged on a straight line or on a circumference, and adjustment of the phase of the AC signals supplied to each antenna allows radio waves with high directivity to be transmitted in arbitral directions. There is no restriction on the wavelength of radio waves which can be transmitted by the phased array antenna according to an embodiment of the present invention, and the wavelength is in the range from 400 MHz to 50 GHz. Typically, this phased array antenna can be used to transmit radio waves in the 400 MHz to 6.0 GHz band, 2.5 GHz to 4.7 GHz band, and 24 GHz to 50 GHz band, for example.

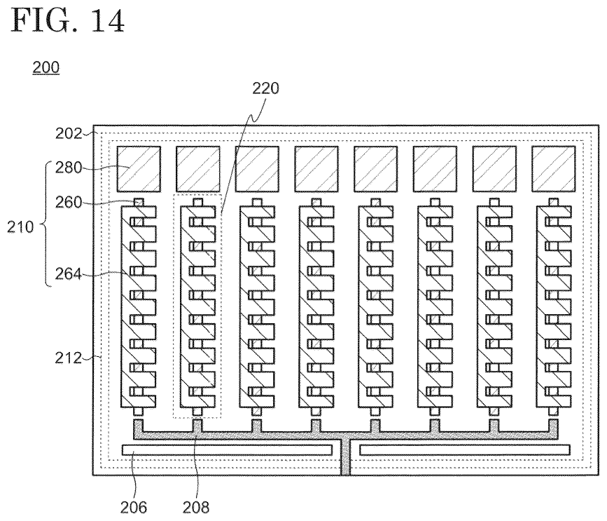

A schematic top view of the phased array antenna 200 is shown in FIG. 14. As shown in FIG. 14, the phased array antenna 200 has a substrate 202 and a counter substrate which is not illustrated in FIG. 14, between which a variety of patterned insulating films, semiconductor films, and conductive films, a liquid crystal layer, and the like are arranged. These films are stacked as appropriate to form a plurality of antennas 210 as well as a driver circuit 206 for driving each antenna 210 and a transmission wiring 208 for transmitting AC signals to the antennas 210. A plurality of terminals which is not illustrated is formed over the substrate 202, and a variety of signals is supplied to the driver circuit 206 from an external circuit (not illustrated) through the terminals. The driver circuit 206 generates signals (scanning signals and control signals) to drive each of the antennas 210 on the basis of the supplied signals and supplies them to the antennas 210 via wirings which are not illustrated in FIG. 14. The substrate 202 and the counter substrate are secured to each other by a sealing material 212, and the plurality of antennas 210, the driver circuit 206, and the transmission wiring 208 are protected by the substrate 202, the counter substrate, and the sealing material 212. A portion of the transmission wiring 208 crosses the sealing material 212 and is exposed from the counter substrate.

Although the plurality of antennas 210 is arranged in one direction in the example shown in FIG. 14, there are no restrictions on the arrangement of the antennas 210. For example, the plurality of antennas 210 may be arranged on a circumference or in a matrix shape with a plurality of rows and a plurality of columns.

### (2) Structure of Antenna

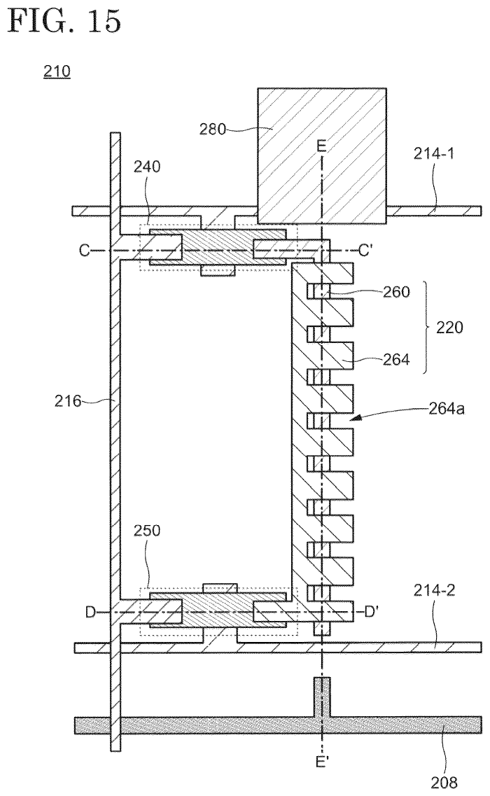

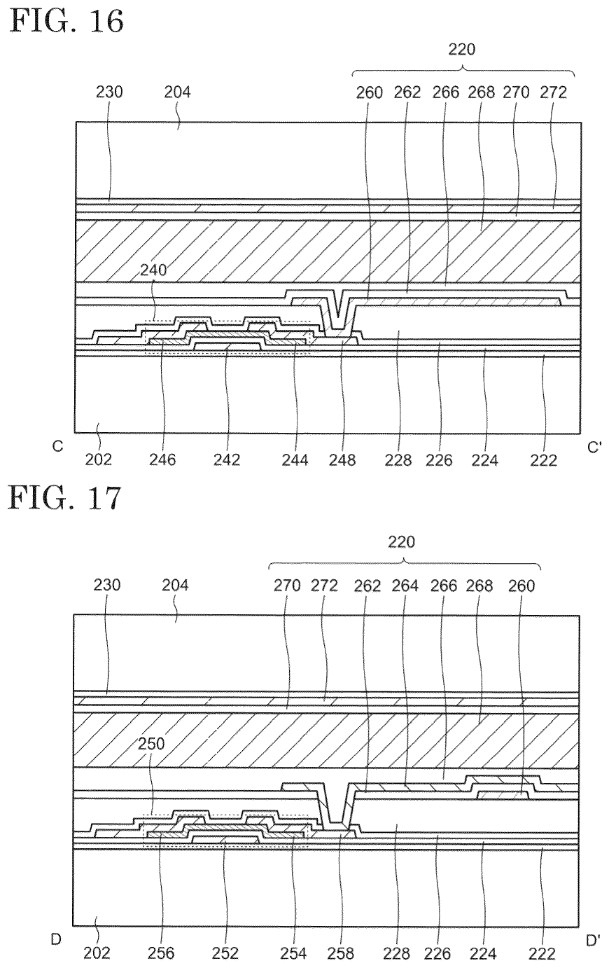

A schematic top view of one antenna 210 is shown in FIG. 15, and schematic views of the cross sections along the chain lines C-C′, D-D′, and E-E′ in FIG. 15 are respectively shown in FIG. 16 to FIG. 18. As shown in these drawings, the antenna 210 has, as its main components, an antenna electrode 280, a phase shifter 220, and at least two transistors (first transistor 240 and second transistor 250) for driving the phase shifter 220.

The phase shifter 220 is arranged between the antenna electrode 280 and the transmission wiring 208. The transmission wiring 208 is a conductive film containing a metal such as molybdenum, tungsten, titanium, aluminum, and copper or an alloy containing a metal selected from these metals, receives input of an AC signal from a transmitter which is not illustrated, and transmits this AC signal to the phase shifter 220 of each antenna 210 utilizing capacitive coupling. In the example shown in FIG. 14, the transmission wiring 208 has a branched structure, and the plurality of branch ends reaches the vicinity of the corresponding phase shifter 220. Thus, AC signals having the same phase and frequency are supplied to the phase shifters 220.

The phase shifter 220 is an element having a function of changing the phase of the AC signals. It is possible to provide the radio waves transmitted from the phased array antenna 200 with directionality and transmit the radio waves to arbitrary directions by changing the amount of phase for each antenna 210.

The antenna electrode 280 is also a conductive film containing the aforementioned metal or alloy and transmits radio waves of a frequency corresponding to the AC signal input from the phase shifter 220 by utilizing capacitive coupling. Hence, the antenna electrode 280 is preferred to have a shape having a plurality of symmetrical axes intersecting each other, such as regular polygons including a square. For example, the antenna electrode 280 may be arranged to have a square shape with one side equal to or greater than 2 mm and equal to or less than 30 mm, depending on the frequency.

As can be understood from FIG. 15 to FIG. 17, the phased array antenna 200 has two gate lines (first gate line 214-1 and second gate line 214-2) for supplying scanning signals to the plurality of antennas 210 as well as a signal line 216 for supplying control signals. The first gate line 214-1 and the second gate line 214-2 extend in the direction in which the plurality of antennas 210 is arranged, and both are electrically connected to all of the antennas 210. On the other hand, the signal lines 118 intersecting the gate lines 214 are provided in the same number as the antennas 210 and are electrically connected to the corresponding antennas 210, respectively.

Each antenna 210 has at least two transistors (first transistor 240 and second transistor 250) for driving the phase shifter 220, and a portion of the first gate line 214-1 and a portion of the second gate line 214-2 respectively structure the gate electrodes of the first transistor 240 and the second transistor 250. In other words, the first transistor 240 and the second transistor 250 are connected to different gate lines, namely the first gate line 214-1 and the second gate line 214-2, respectively. Thus, the first gate line 214-1 is electrically connected to the gate electrodes of the first transistors 240 of all of the antennas 210. Meanwhile, the second gate line 214-2 is electrically connected to the gate electrodes of the second transistors 250 of all of the antennas 210. The first gate line 214-1 and the second gate line 214-2 are individually supplied with potentials (scanning signals) by the drive circuit 206. Thus, the first transistor 240 and the second transistor 250 can be driven and controlled independently from each other in each antenna 210. Although the number of gate lines 214 is twice as many as in a normal liquid crystal display, the load on the driver circuit 206 is small because the number of antennas in a phased array antenna is generally much smaller than the number of pixels in a liquid crystal display. Therefore, all of the antennas 210, more specifically, the phase shifters 220 included in the 210 antennas, can be switched on and off at high speed.

A part of each signal line 216 serves as a terminal 246 of the first transistor 240 and another part serves as a terminal 256 of the second transistor 250 (see FIG. 15). Thus, each signal line 216 is electrically connected to the first transistor 240 and the second transistor 250 of one antenna 210 and provides individual potentials (i.e., variable potentials) to each transistor as the control signals.

As shown in FIG. 16 and FIG. 17, the first transistor 240 and the second transistor 250 are disposed over the substrate 202 either directly or through an undercoat 222 which is an optional component. In the example shown in FIG. 15 and FIG. 16, the first transistor 240 is composed of a gate electrode 242, a gate insulating film 224 over the gate electrode 242, a semiconductor film 244 located over the gate insulating film 224 and overlapping the gate electrode 242, and terminals 246 and 248 electrically connected to the semiconductor film 244. Similarly, the second transistor 250 is composed of a gate electrode 252, the gate insulating film 224 over the gate electrode 252, a semiconductor film 254 located over the gate insulating film 224 and overlapping the gate electrode 252, and terminals 256 and 258 electrically connected to the semiconductor film 254. Although the first transistor 240 and the second transistor 250 both have a bottom-gate structure in the examples shown in FIG. 15 to FIG. 17, there is no restriction on these structures. The first transistor 240 and the second transistor 250 may have a top-gate structure or may each have gate electrodes over and under the semiconductor film. There is also no restriction on the vertical relationship between the terminals 246 and 248 and the semiconductor film 244, and the former may be located under the latter. The same is applied to the vertical relationship between the terminals 256 and 258 and the semiconductor film 254.

A leveling film 228 is disposed over the first transistor 240 and the second transistor 250 to absorb the unevenness caused by these transistors and provide a flat surface. As an optional component, a first interlayer insulating film 226 may be provided between the first transistor 240 and the second transistor 250 and the planarization film 228. Each antenna 210 may be further provided with a variety of elements such as one or a plurality of transistors and one or a plurality of capacitor elements in addition to the first transistor 240 and the second transistor 250. Since the configurations from the substrate 102 to the leveling film 228 are similar to those of the First Embodiment, further description is omitted.

The phase shifter 220 is provided over the leveling film 228. The phase shifter 220 includes, as basic components thereof, a microstrip line 260, a second interlayer insulating film 262, an auxiliary electrode 264, a first orientation film 266, a second orientation film 270, a liquid crystal layer 268, and a counter electrode 272.

The microstrip line 260 is electrically connected to one terminal 248 of the first transistor 240 through an opening formed in the leveling film 228 and the first interlayer insulating film 226. This structure allows the control signals to be applied to the microstrip line 260 from the signal line 216 through the terminal 246, the semiconductor film 244, and the terminal 248 when the first transistor 240 is turned on. The microstrip line 260 is an electrode with a large aspect ratio (e.g., length/width is equal to or greater than 2 and equal to or less than 500), and its longitudinal direction is arranged perpendicular to the direction in which the plurality of antennas 210 is arranged in the examples shown in FIG. 14, and FIG. 15, and the like. The length of the microstrip line 260 may be equal to or greater than 1 mm and equal to or less than 10 mm, and the width thereof may be equal to or greater than 20 μm and equal to or less than 500 μm, for example. The microstrip line 260 is configured to include a metal such as molybdenum, tungsten, titanium, aluminum, and copper or an alloy including a metal selected from these metals.

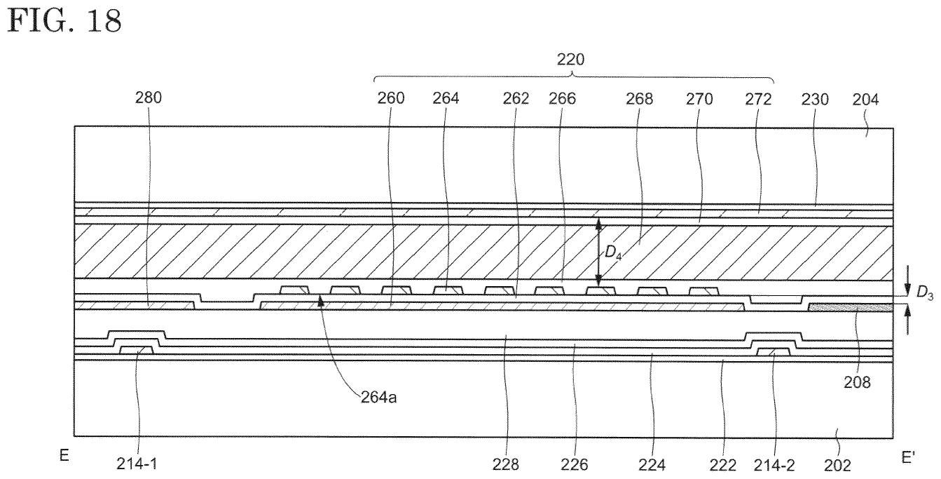

As can be understood from FIG. 18, the microstrip line 260 may be arranged in the same layer as the antenna electrode 280 and the transmission wiring 208. Thus, the microstrip line 260, the antenna electrode 280, and the transmission wiring 208 may have the same composition and thickness. The microstrip line 260, the antenna electrode 280, and the transmission wiring 208 are spaced away from one another and are electrically insulated by the second interlayer insulating film 262. The spacing between the microstrip line 260 and the antenna electrode 280 and the spacing between the microstrip line 260 and the transmission wiring 208 may be set to be, for example, equal to or greater than 1 μm and equal to or less than 20 μm.

On the other hand, the auxiliary electrode 264 is electrically connected to one of the terminals 258 of the second transistor 250 through an opening formed in the leveling film 228, the first interlayer insulating film 226, and the second interlayer insulating film 262. With this structure, the control signals are applied from the signal line 216 to the auxiliary electrode 264 through the terminal 256, the semiconductor film 254, and the terminal 258 when the second transistor 250 is turned on. Therefore, arbitrary potentials (i.e., variable potentials) can be supplied to the microstrip line 260 and the auxiliary electrode 264 by switching the first transistor 240 and the second transistor 250 on and off as appropriate. The auxiliary electrode 264 may also be configured to include the aforementioned metal or alloy or may include a conductive oxide exhibiting a light-transmitting property, such as ITO and indium-zinc oxide (IZO). The microstrip line 260 and the auxiliary electrode 264 are electrically insulated by the second interlayer insulating film 262 located therebetween. The second interlayer insulating film 262 may also be composed of one or a plurality of films containing a silicon-containing inorganic compound.

Here, the auxiliary electrode 264 has at least one, preferably a plurality of cutoffs 264a (FIG. 15). In other words, the auxiliary electrode 264 may have a comb shape. The cutoff 264a overlaps the microstrip lines 260, and thus a portion of the microstrip line 260 is exposed from the auxiliary electrode 264. Depending on the frequency, the length of the cutoff 264a is equal to or greater than 10 μm and equal to or less than 400 μm, the width is equal to or greater than 1 μm and equal to or less than 100 μm, and the aspect ratio (length/width) is equal to or greater than 2 and equal to or less than 400, for example. The number of cutoffs 264a provided in each auxiliary electrode 264 may be selected from a range equal to or greater than 10 and equal to or less than 100, for example. Alternatively, although not illustrated, each auxiliary electrode 264 may have one or a plurality of slits as in the radio-wave reflecting element 120 of the First Embodiment. The length, the width, the aspect ratio, and number of slits may also be selected as appropriate from the ranges described above.

Both the first orientation film 266 and the second orientation film 270 are provided to cover the microstrip line 260 and the auxiliary electrode 264 and sandwich the liquid crystal layer 268. The orientation directions of the first orientation film 266 and the second orientation film 270 may be set arbitrarily, which may be parallel or perpendicular to the longitudinal direction of the cutoff 264a (or slit) or may be inclined at any angle from the longitudinal direction. The orientation directions of the first orientation film 266 and the second orientation film 270 may be the same as or different from each other. For example, the orientation directions of the first orientation film 266 and the second orientation film 270 may be orthogonal. Since the structures of the first orientation film 266, the second orientation film 270, and the liquid crystal layer 268 may be similar to those of the first orientation film 168, the second orientation film 172, and the liquid crystal layer 170 of the radio-wave reflecting element 120 of the First Embodiment, respectively, further description is omitted.

The counter electrode 272 is provided over the liquid crystal layer 268 through the second orientation film 270. The counter electrode 272 may be provided as a single integrated electrode across the plurality of phase shifters 220 so as to be shared by the plurality of phase shifters 220. Therefore, the counter electrode 272 is also referred to as a common electrode. The counter electrode 272 is supplied with a common potential, which is a constant potential, from an external circuit which is not illustrated either directly or through the drive circuit 206. The potential difference between the counter electrode 272 and the microstrip line 260 and/or between the counter electrode 272 and the auxiliary electrode 264 generates a longitudinal electric field in the liquid crystal layer 268, and the orientation of the liquid crystal molecules is changed by the longitudinal electric field, thereby controlling the permittivity of the liquid crystal layer 268. Since the phase shifter 220 may or may not transmit visible light, the counter electrode 272 may contain the aforementioned metal or alloy or a conductive oxide such as ITO and IZO, similar to the microstrip line 260 and the auxiliary electrode 264.

The phase shifter 220 is configured so that the distance D₃ between the microstrip line 260 and the auxiliary electrode 264 (the distance from a top surface of the microstrip line 260 to a bottom surface of the auxiliary electrode 264) is smaller than the distance D₄ between the auxiliary electrode 264 and the counter electrode 272 (the distance from a top surface of the auxiliary electrode 264 to a bottom surface of the counter electrodes 272) (see FIG. 18). The distance D₃ is mainly determined by the second interlayer dielectric 262 and is, for example, equal to or greater than 50 nm and equal to or less than 5 μm. The distance D₄ is mainly determined by the liquid crystal layer 268, the first orientation film 266, and the second orientation film 270 and is approximately the summation of the thicknesses of the liquid crystal layer 268 (e.g., equal to or greater than 20 μm and equal to or less than 50 μm or equal to or greater than 30 μm and equal to or less than 50 μm), the first orientation films 266, and the second orientation film 270. For example, the distance D₄ may be set in a range equal to or greater than 200 times and equal to or less than 500 times the distance D₃.

The counter substrate 204 may have the same configuration as the substrate 202. The substrate 202 and the counter substrate 204 are sealed by the sealing material 212 (FIG. 14), and the liquid crystal layer 268 is sealed within the space created by the sealing material 212, the substrate 202, and the counter substrate 204. As shown in FIG. 16 to FIG. 18, an undercoat 230 may be provided over a surface of the counter substrate 204 on the liquid crystal layer 268 side to prevent impurities in the counter substrate 204 from diffusing to the liquid crystal layer 268 side. The undercoat 230 may have the same configuration as the undercoat 222.

### 2. Driving Method of Phased Array Antenna

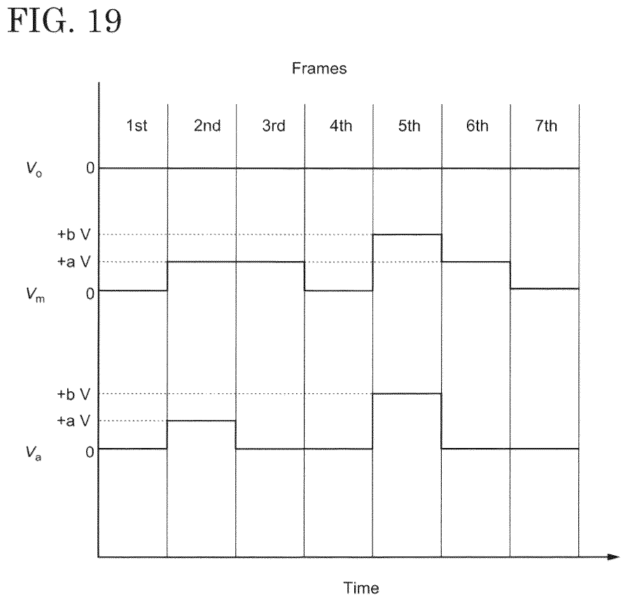

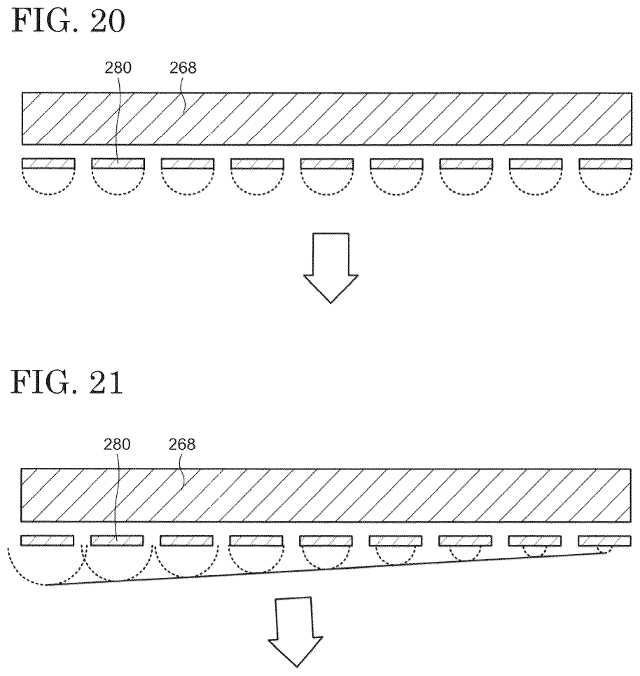

A driving method of the phased array antenna 200 is explained below using FIG. 19 through FIG. 21. FIG. 19 is an example of a timing chart for driving the phased array antenna 200, where the changes of the potentials applied to the counter electrode 272, the microstrip line 260, and the auxiliary electrode 264 in seven consecutive frames are schematically shown for one antenna 210. FIG. 20 and FIG. 21 are schematic cross-sectional views of the liquid crystal layer 268 and the antenna electrodes 280 of the plurality of antennas 210.

According to the timing chart in FIG. 19, the phase shifter 220 is in the off state in the first frame, the fourth frame, and the seventh frame. In contrast, the phase shifter 220 is in the on state in the second frame and fifth frame, in which an electric field is formed in the liquid crystal layer 268. Thus, the transmission direction of radio waves is controlled in the second frame and the fifth frame. In the example shown here, the strengths of the electric field formed in the liquid crystal layer 268 in the second frame and the fifth frame are different from each other, and the latter is larger than the former. The third frame and the sixth frame are also referred to as the overdrive period, and high-speed switching of the transmission direction of radio waves is feasible by providing these frames as described below.

### (1) Off State

In the first frame, the microstrip lines 260, the auxiliary electrode 264, and the counter electrode 272 are each supplied with the same potential (e.g., ground potential of 0 V) in all of the antennas 210. In this state, these components are equipotential to one another, and no electric field is generated in the liquid crystal layer 268. Therefore, although not illustrated, the liquid crystal molecules in the liquid crystal layer 268 are homogeneously oriented according to the orientation directions of the first orientation film 266 and the second orientation film 270, similar to the liquid crystal layer 170 of the radio-wave reflecting element 120 of the First Embodiment. As a result, the permittivity of the liquid crystal layer 170 is the same among all of the antennas 210. The phase of the AC signal transmitted from the transmission wiring 208 to the microstrip line 260 varies with the permittivity of the liquid crystal layer 268. Since the permittivity of the liquid crystal layer 170 is the same between all of the phase shifters 220 in the off state, the spread (phase) of the radio waves transmitted from above and below the antenna electrodes 280 is identical as represented by the dotted arcs in FIG. 20 which is a schematic cross-sectional view of the plurality of antennas 210. Therefore, the radio waves are transmitted in the front direction of the phased array antenna 200 (the side where the antenna electrodes 280 are located) so as to direct in the normal direction of the antenna electrodes 280 (see the arrow in FIG. 20).

### (2) On State

In the second frame following the first frame, the phase shifter 220 is turned on. Specifically, the first transistor 240 is turned on, and the second transistor 250 is kept off in each phase shifter 220, while maintaining the potential V₀ of the counter electrode 272 at 0 V. In this state, an arbitrary potential different from the potential V₀ of the counter electrode 272 (in this case, a potential of +aV) is supplied from the signal line 216 to the microstrip line 260. This operation causes the potential Vₘ of the microstrip line 260 to be +aV.

The first transistor 240 is then turned off. This operation maintains the potential Vₘ of the microstrip line 260 at +aV. Next, the second transistor 250 is turned on, while maintaining the first transistor 240 in the off state. In this state, an arbitrary potential different from the potential V₀ (here, a potential of +aV) is supplied from the signal line 216. As a result, the potential Vₐ of the auxiliary electrode 264 becomes +aV. Although the potential Vₐ of the auxiliary electrode 264 is set after the potential Vₘ of the microstrip line 260 is set in the explanation above, this order is arbitrary. Although the potential Vₘ of the microstrip line 260 and the potential Vₐ of the auxiliary electrode 264 may be the same as or different from each other, the potentials of these electrodes are preferred to be the same to avoid generating a transverse electric field caused by the potential difference between the microstrip line 260 and the auxiliary electrode 264.

The above operation creates a potential difference between the microstrip line 260 and the counter electrode 272 and between the auxiliary electrode 264 and the counter electrode 272. As a result, although not illustrated, a longitudinal electric field is generated in the liquid crystal layer 268 (see the dotted arrow in FIG. 8), similar to the liquid crystal layer 170 of the radio-wave reflecting element 120 of the First Embodiment. The potential Vₘ of the microstrip line 260 and the potential Vₐ of the auxiliary electrode 264 at this time are determined by the transmission direction of radio waves. As described above, the phase of the AC signal transmitted through the microstrip line 260 varies with the permittivity of the liquid crystal layer 268, and the phase change increases with increasing change in permittivity. Moreover, the change in permittivity also depends on the strength of the electric field generated in the liquid crystal layer 268. Therefore, when the phase of the AC signal is to be significantly changed, a potential which is significantly different from the potential Vₒ of the counter electrode 272 may be provided to the microstrip line 260 and the auxiliary electrode 264.

Similar to the radio-wave reflecting element 120 of the First Embodiment, when the longitudinal electric field is generated, the liquid crystal molecules rise, resulting in a change in the permittivity of the liquid crystal layer 268 due to the permittivity anisotropy of the liquid crystal molecules. Therefore, the phase of the AC signal can be changed for each antenna 210 by changing the intensity of the longitudinal electric field for each phase shifter 220. As a result, as indicated by the dotted semicircles in FIG. 21, the phase of the radio waves transmitted from the antenna electrode 280 can be changed for each antenna 210 to tilt the isophase plane. That is, the direction of the radio waves transmitted toward the antenna electrode 280 side can be changed (see the white arrow in FIG. 21).

When the phase shifter 220 is then returned to the off state, the potential Vₐ of the auxiliary electrode 264 is returned to its initial potential of 0 V in the third frame, while the potential Vₒ of the counter electrode 272 and the potential Vₘ of the microstrip line 260 are maintained at 0 V and +aV, respectively. This operation creates a potential difference between the microstrip line 260 and the auxiliary electrode 264, resulting in the transverse electric field between the microstrip line 260 and the auxiliary electrode 264, similar to the liquid crystal layer 170 of the radio-wave reflecting element 120 (see FIG. 9). On the other hand, there is still a potential difference between the microstrip line 260 and the counter electrode 272. However, since the distance D₃ is extremely large compared to the distance D₄ as mentioned above, the longitudinal electric field can be ignored compared with this transverse electric field. As a result, the liquid crystal molecules which rise in the second frame can be forced back to their original homogeneous orientation using the transverse electric field in the third frame. The contribution of the driving force of the transverse electric field enables the permittivity of the liquid crystal layer 268 to be rapidly returned to its original permittivity. The potential Vₘ of the microstrip line 260 is then returned to its initial potential (0 V) in the fourth frame to shift to the off state.

When shifting to the on state to change the permittivity even more significantly (fifth frame), a larger potential (in the example in FIG. 19, a potential of +b, where b>a) may be applied to each of the microstrip line 260 and the auxiliary electrode 264. The same is applied when shifting to the off state again, and no potential difference is provided between the auxiliary electrode 264 and the counter electrode 272 in the sixth frame following the fifth frame, while a potential difference is provided between the auxiliary electrode 264 and the microstrip line 260 to form the transverse electric field. This operation allows the orientation state of the liquid crystal layer 268 to be rapidly returned to the homogeneous orientation.

Note that, in the phase shifter 220, the inverted driving method may be employed to prevent burn-in of the liquid crystal layer 268 as in the radio-wave reflecting element 120. That is, the polarities of the potentials Vₘ and Vₐ of the microstrip line 260 and the auxiliary electrode 264 may be inverted with respect to the potential Vₒ of the counter electrode 272 between consecutive on-state frames.

As described above, when the liquid crystal molecules which rise due to the longitudinal electric field are returned to the homogeneous orientation, the van der Waals force as well as the transverse electric field between the auxiliary electrode 264 and the microstrip line 260 can be utilized in the antenna 210 according to an embodiment of the present invention and the phased array antenna 200 having the antenna 210, similar to the intelligent reflecting surface 100. Hence, the homogeneous orientation can be rapidly reproduced, and as a result, the transmission direction of radio waves of the phased array antenna 200 can be switched at high speed. Therefore, implementation of an embodiment of the present invention enables the production of a phased array antenna capable of changing the transmission direction of radio waves at high speed.

The aforementioned modes described as the embodiments of the present invention can be implemented by appropriately combining with each other as long as no contradiction is caused. Furthermore, any mode which is realized by persons ordinarily skilled in the art through the appropriate addition, deletion, or design change of elements or through the addition, deletion, or condition change of a process on the basis of the display device according to each embodiment is included in the scope of the present invention as long as they possess the concept of the present invention.

It is understood that another effect different from that provided by each of the aforementioned embodiments is achieved by the present invention if the effect is obvious from the description in the specification or readily conceived by persons ordinarily skilled in the art.

What is claimed is:

1. A radio-wave reflecting element comprising:
a patch electrode;
an insulating film over the patch electrode;
an auxiliary electrode located over the insulating film and having at least one slit or cutoff overlapping the patch electrode;
a liquid crystal layer over the auxiliary electrode; and
a counter electrode over the liquid crystal layer,
wherein the patch electrode and the auxiliary electrode are configured to be independently applied with a variable potential.

2. The radio-wave reflecting element according to claim 1,
wherein a distance between the auxiliary electrode and the counter electrode is larger than a distance between the auxiliary electrode and the patch electrode.

3. The radio-wave reflecting element according to claim 1,
wherein the counter electrode is configured to be applied with a constant potential.

4. The radio-wave reflecting element according to claim 1, further comprising a first transistor and a second transistor electrically connected to the patch electrode and the auxiliary electrode, respectively.

5. The radio-wave reflecting element according to claim 1, further comprising:
a first orientation film between the auxiliary electrode and the liquid crystal layer; and
a second orientation film between the liquid crystal layer and the counter electrode.

6. An intelligent reflecting surface comprising a plurality of radio-wave reflecting elements arranged in a matrix shape having a plurality of rows and a plurality of columns, each of the plurality of radio-wave reflecting elements comprising:
a patch electrode;
an insulating film over the patch electrode;
an auxiliary electrode located over the insulating film and having at least one slit or a cutoff overlapping the patch electrode;
a liquid crystal layer over the auxiliary electrode; and
a counter electrode located over the liquid crystal layer and shared by the plurality of radio-wave reflecting elements,
wherein the patch electrode and the auxiliary electrode are configured to be independently applied with a variable potential.

7. The intelligent reflecting surface according to claim 6,
wherein a distance between the auxiliary electrode and the counter electrode is larger than a distance between the auxiliary electrode and the patch electrode.

8. The intelligent reflecting surface according to claim 6,
wherein the counter electrode is configured to be applied with a constant potential.

9. The intelligent reflecting surface according to claim 6,
wherein each of the radio-wave reflecting elements further comprises a first transistor and a second transistor electrically connected to the patch electrode and the auxiliary electrode, respectively.

10. The intelligent reflecting surface according to claim 6,
wherein each of the radio-wave reflecting elements further comprises:
a first orientation film between the auxiliary electrode and the liquid crystal layer; and
a second orientation film between the liquid crystal layer and the counter electrode.

11. The intelligent reflecting surface according to claim 9, further comprising:
a first gate line and a second gate line each extending in a row direction; and
a signal line intersecting the first gate line and the second gate line,
wherein the first gate line is electrically connected to the first transistor of a first radio-wave reflecting element selected from the plurality of radio-wave reflecting elements,
the second gate line is electrically connected to the second transistor of the first radio-wave reflecting element, and
the signal line is electrically connected to the first transistor and the second transistor of the first radio-wave reflecting element.

12. The intelligent reflecting surface according to claim 11,
wherein the signal line is electrically connected to the first transistor and the second transistor of a second radio-wave reflecting element selected from the plurality of radio-wave reflecting elements and located in the same column as the first ratio-wave reflecting element.

13. The intelligent reflecting surface according to claim 9, further comprising:
a gate line extending in a row direction; and
a first signal line and a second signal line intersecting the gate line,
wherein the gate line is electrically connected to the first transistor and the second transistor of a first radio-wave reflecting element selected from the plurality of radio-wave reflecting elements,
the first signal line is electrically connected to the first transistor of the first radio-wave reflecting element, and
the second signal line is electrically connected to the second transistor of the first radio-wave reflecting element.

14. The intelligent reflecting surface according to claim 13,
wherein the gate line is electrically connected to the first transistor and the second transistor of a second radio-wave reflecting element selected from the plurality of radio-wave reflecting elements and located in the same row as the first radio-wave reflecting element.

15. An antenna comprising an antenna electrode and a phase shifter, wherein the phase shifter comprises:
a microstrip line existing in the same layer as the antenna electrode;
an insulating film over the microstrip line;
an auxiliary electrode located over the insulating film and having at least one slit or a cutoff overlapping the microstrip line;
a liquid crystal layer over the auxiliary electrode; and
a counter electrode over the liquid crystal layer, and
the antenna electrode is electrically insulated from the microstrip line through the insulating film.

16. The antenna according to claim 15,
wherein a distance between the auxiliary electrode and the counter electrode is larger than a distance between the auxiliary electrode and the microstrip line.

17. The antenna according to claim 15, further comprising a transmission wiring existing in the same layer as the microstrip line and electrically insulated from the microstrip line through the insulating film.

18. The antenna according to claim 15,
wherein the microstrip line and the auxiliary electrode are configured to be independently applied with a variable potential, and
the counter electrode is configured to be applied with a constant potential.

19. The antenna according to claim 15, further comprising a first transistor and a second transistor electrically connected to the microstrip line and the auxiliary electrode, respectively.

20. The antenna according to claim 15, further comprising:
a first orientation film between the auxiliary electrode and the liquid crystal layer; and
a second orientation film between the liquid crystal layer and the counter electrode.
